(19) United States
(12) Patent Application Publication
(10) Pub. No.: US 2014/0344297 A1
(43) Pub. Date: Nov. 20, 2014

(54) SYSTEM AND METHOD FOR MANAGING MASTER DATA TO RESOLVE REFERENCE DATA OF BUSINESS TRANSACTIONS

(71) Applicant: KPMG LLP, New York, NY (US)

(72) Inventor: Prabhakar Jayade, Plainsboro, NJ (US)

(73) Assignee: KPMG LLP, New York, NY (US)

(21) Appl. No.: 14/243,879

(22) Filed: Apr. 2, 2014

Related U.S. Application Data
(60) Provisional application No. 61/807,384, filed on Apr. 2, 2013.

(51) Int. Cl. G06F 17/30

(52) U.S. Cl. CPC G06F 17/30011
USPC 707/755

(57) ABSTRACT

A system and method of reconciling reference data of a business transaction may include parsing the document to identify at least one set of a subject, predicate, and object data contained within the document in response to receiving a document associated with a business transaction. A determination of at least one predicate of interest from the set(s) of a subject, predicate, and object data may be made. A transaction data set in an RDF triple data format for each set of subject, predicate, and object data inclusive of the at least one predicate of interest may be generated. A determination of reference data of a transaction data set may be made. The reference data may be compared with master data representative of potential identities to which the reference data of the business transaction refers so that a determination of a correct identity of the reference data may be made.

### RELATED APPLICATIONS

This application claims priority to co-pending U.S. Provisional Application Ser. No. 61/807,384 filed Apr. 2, 2013 and entitled “System and Method for Client Onboarding”; the contents of which are hereby incorporated by reference in their entirety.

### BACKGROUND

All business transactions include transaction data that include a time (e.g., date/time of sale), numerical value (e.g., sale price), and reference transaction data (e.g., identify of goods/services being transacted and identities of the parties). For the purposes of this application, reference data is information of a business transaction that represents non-variable or minimally variable facts of the transaction. Reference data is often derived from master data, which is reference data that is stored in a database often used for populating reference data in transaction data. As an example, a transaction may be a stock trade that includes a buyer name, seller name, company name of stock being traded, addresses of the buyer/seller parties and company, number of shares being traded, date of trade, and so forth. The reference data in this example includes buyer name, seller names, company name of stock being traded, and addresses of the parties and stock, while the number of shares being traded and date of trade are variables of the business transaction and are not considered to be reference data.

Companies that perform business transactions, especially large companies (e.g., Tier-I banks, financial institution, shipping companies, etc.) that are segmented into departments and groups that perform different functions as part of the business transactions often include a “front office,” “middle office,” and “back office” to complete a transaction. In the case of a bank or financial institution trading stock, the “front office” may perform the trade, the “middle office” may account for the trade, and the “back office” may settle the trade. The same or different configurations of businesses exist in other fields, as well. As an example of a stock trade transaction process, when a stock, such as Goldman Sachs, is traded, the “front office” may use the abbreviation GS&Co. to refer to Goldman Sachs because it uses Bloomberg as a data source for master data in conducting stock trades. The “middle office,” however, may use Kingsland as its data source for master data, and the “back office” may use Thompson Reuters as its data source for master data. For the purposes of this application, master data is data that is maintained by a company or received by a third-party (e.g., Bloomberg) for use in creating and/or verifying reference data of a transaction. Thus, as a result of the bank or financial institution using different sources of master data that differ for the same entity, the stock trade for Goldman Sachs does not settle if a reference data mismatch cannot be resolved in a certain period of time. It is estimated that 25% of stock trades fail to settle due to this and other reference data problems, which results in penalties for banks or financial institution. The same problem of using different master data exists between different trading entities, such as two trade groups that are on opposite sides of a stock trade. That is, different banks or financial institutions using different data sources for master data are often unable to settle a trade as a result of mismatched reference data.

Master data mismatches between data systems are estimated to cost the industry nearly $800B globally of unnecessary work to resolve business transactions due to inconsistencies or mismatches in master data and consequently reference data, and about $70B per year is spent trying to produce “clean” master data. The reason for the master data not being “clean” is often a result of legacy systems having different master data. And, because there are many thousands of legacy systems with different master data, the problem with reference data mismatches is pervasive throughout many industries, such as the medical industry (e.g., patient names with and without middle initial), shipping industry (e.g., different reference names of addresses—some include building name others do not), transportation industry (e.g., different reference names of starting and ending facilities or addresses), and so on.

### SUMMARY

So as to improve or eliminate the situation of reference data mismatches, the principles of the present invention provides for managing master data by utilizing data modeling. As a result of using data modeling, reference data of a business transaction may be able to be instantaneously correlated with correct master data. The principles of the present invention provide for the use of patterned designs that include decision models, semantic models, and governance models along with semantic Web standards, such as resource description framework (RDF or RDF triple) to model transaction data, inclusive of reference data to be compared with master data, so as to enable a system to instantaneously identify an actual identity of the reference data or recognize that a problem exists with the reference data, thereby enabling the business transaction to be performed or resolved quickly and efficiently.

One method of reconciling reference data of a business transaction may include parsing the document to identify at least one set of a subject, predicate, and object data contained within the document in response to receiving a document associated with a business transaction. A determination of at least one predicate of interest from the set(s) of a subject, predicate, and object data may be made. A transaction data set in an RDF triple data format for each set of subject, predicate, and object data inclusive of the at least one predicate of interest may be generated. A determination of reference data of a transaction data set may be made. A comparison of the reference data with master data representative of potential identities to which the reference data of the business transaction refers may be made so that a determination of a correct identity of the reference data may be made.

One embodiment of a system of reconciling reference data of a business transaction may include a storage unit and a processing unit in communication with the storage unit. The processing unit may be configured to parse the document to identify at least one set of a subject, predicate, and object data contained within the document in response to receiving a document associated with a business transaction. At least one predicate of interest from the at least one set of a subject, predicate, and object data may be determined. A transaction data set in an RDF triple data format for each set of subject, predicate, and object data inclusive of the at least one predicate of interest may be generated. Reference data of a transaction data set may be determined. The reference data may be compared with master data representative of potential identities to which the reference data of the business transaction refers so that a correct identity of the reference data may be determined.

### BRIEF DESCRIPTION

A more complete understanding of the method and apparatus of the present invention may be obtained by reference to the following Detailed Description when taken in conjunction with the accompanying Drawings wherein:

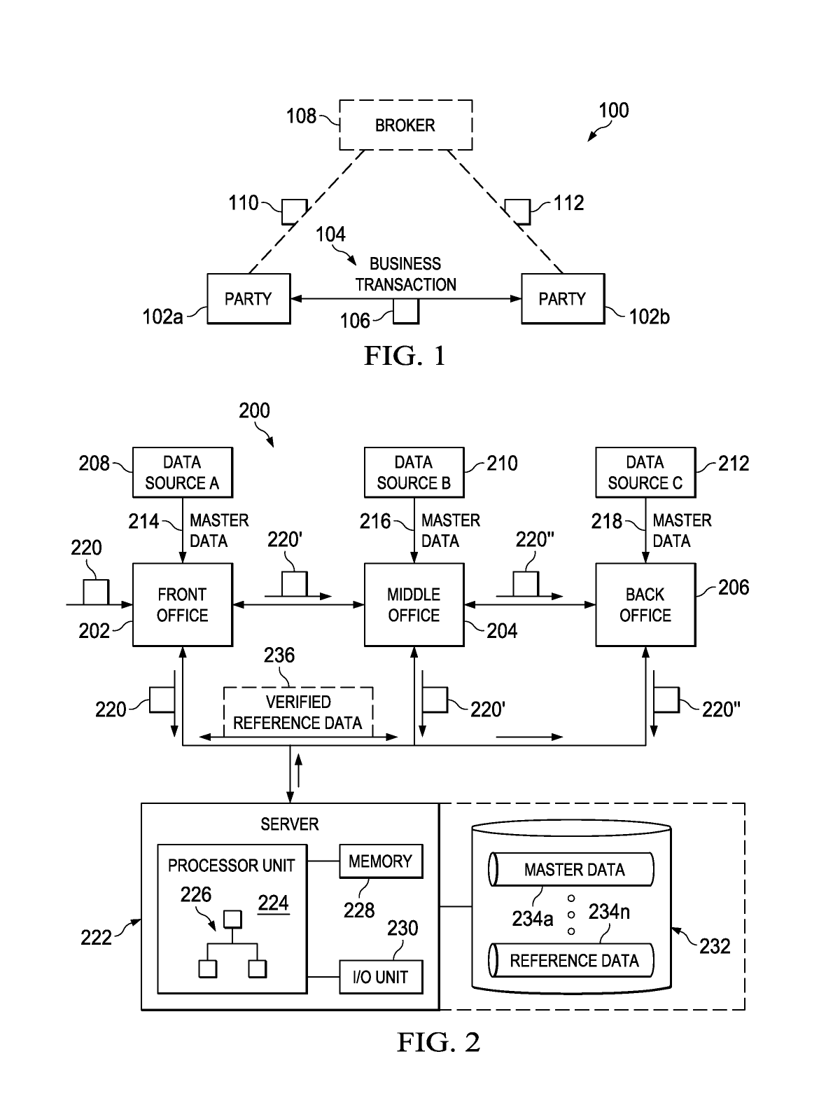

FIG. 1 is an illustration of an illustrative business transaction environment between two parties;

FIG. 2 is an illustration of an illustrative corporate environment in which a business transaction can be supported;

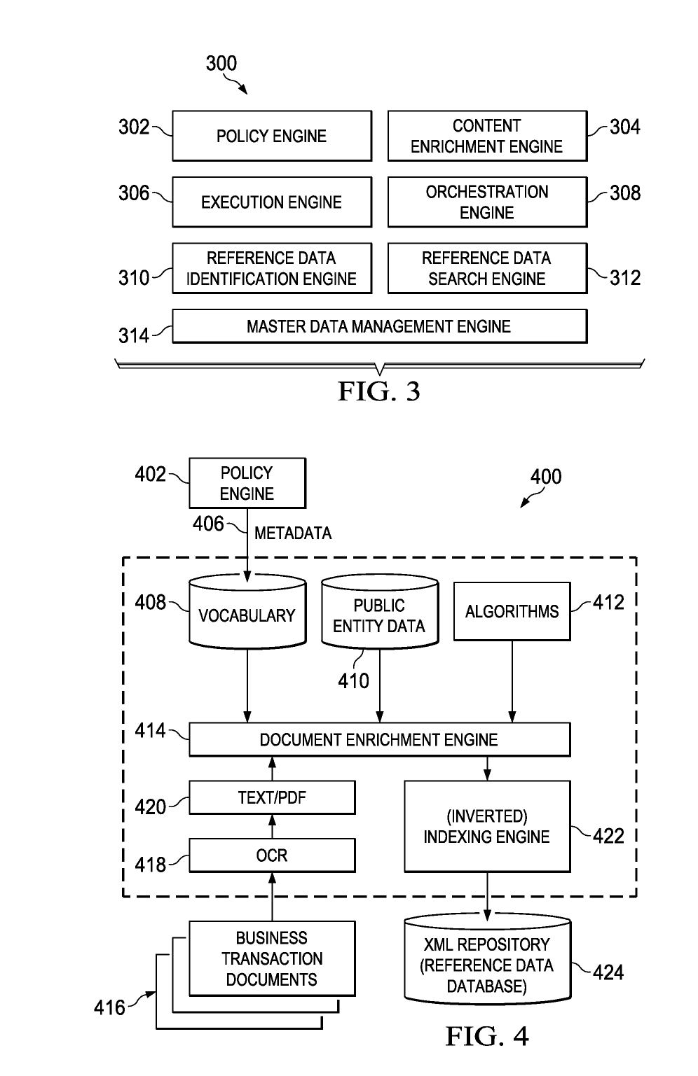

FIG. 3 is a block diagram of a illustrative modules that may be executed by a computing system for managing and processing business;

FIG. 4 is a block diagram of an illustrative content enrichment framework;

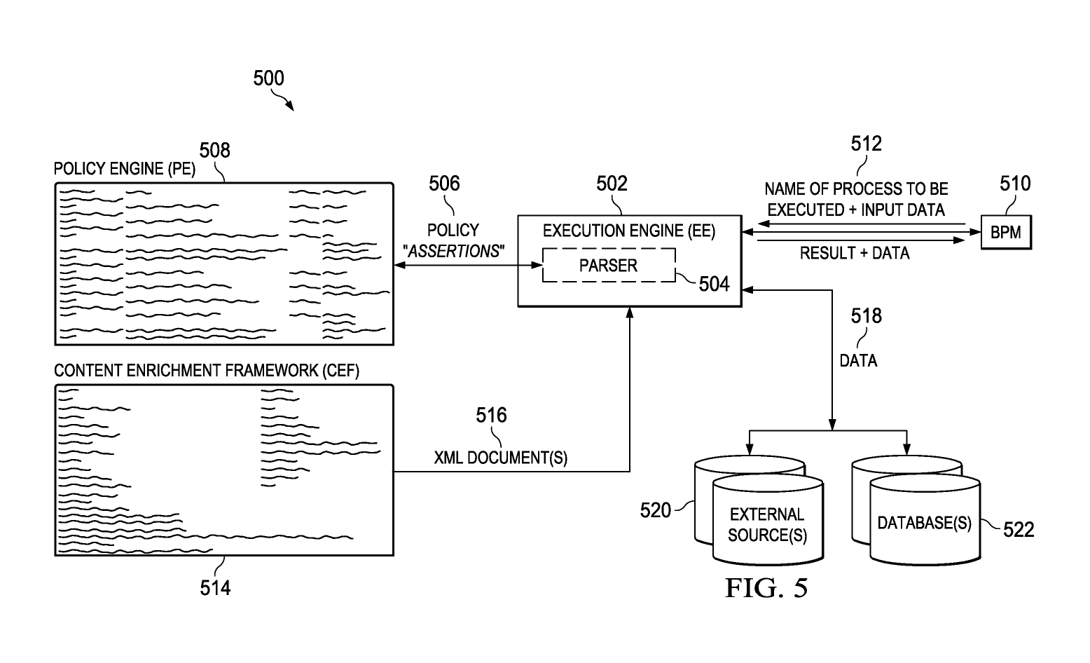

FIG. 5 is an illustration of an illustrative execution engine environment;

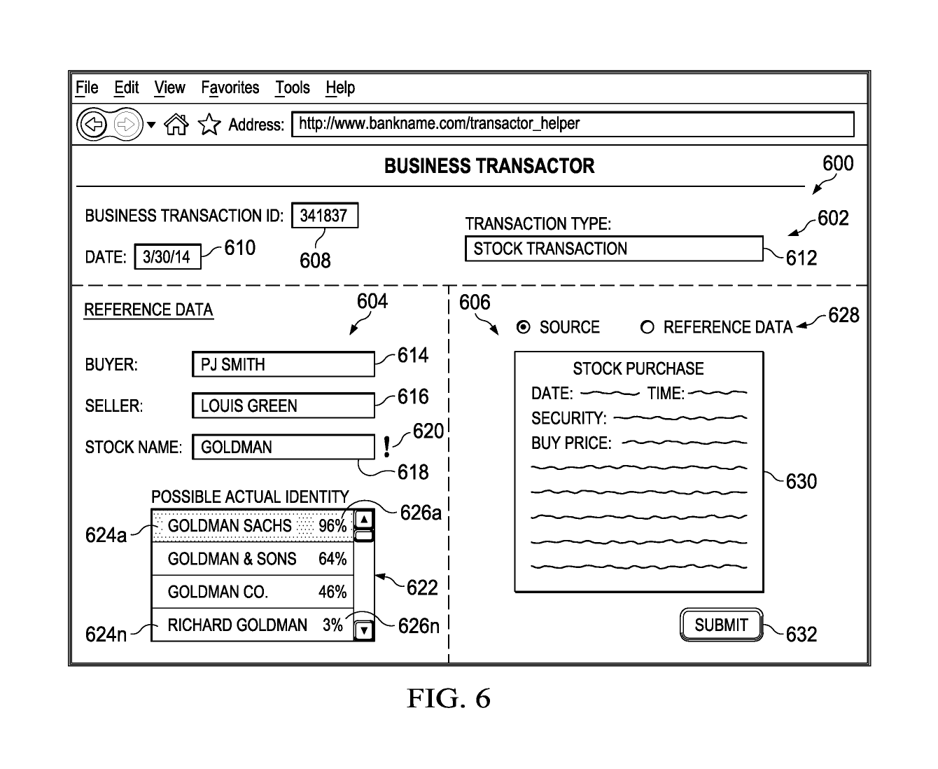

FIG. 6 is a screenshot of an illustrative user interface that enables a user to select master data of which reference data is to be identified;

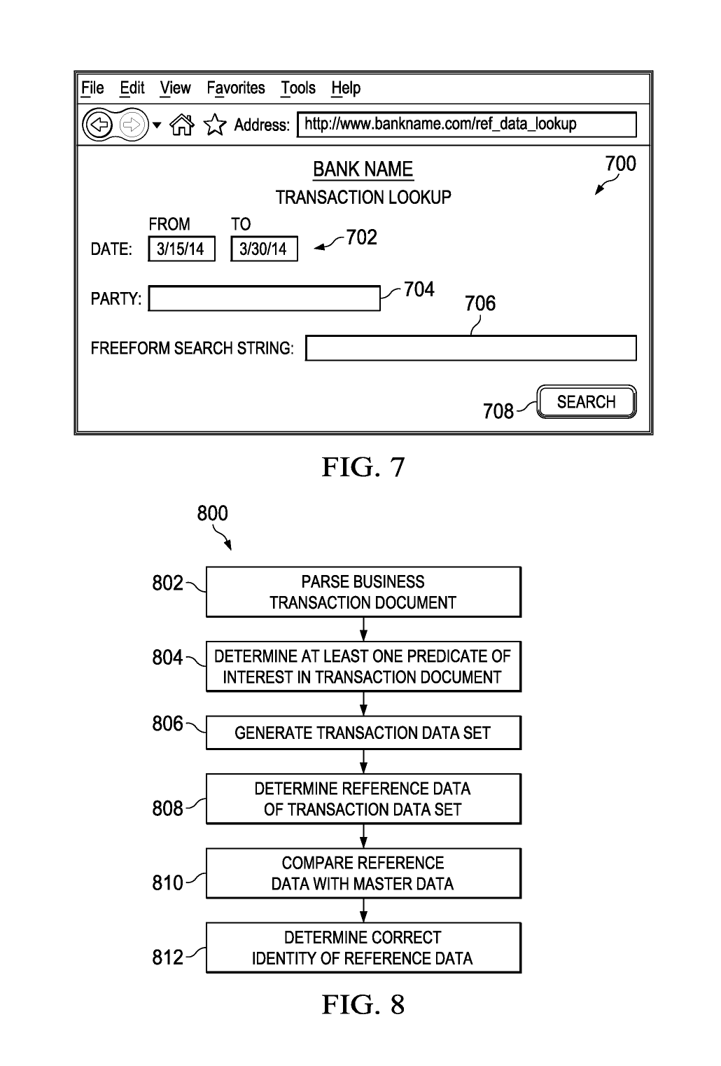

FIG. 7 is a screenshot of an illustrative user interface that enables a user to search for business transaction data of a business transaction document; and

FIG. 8 is a flow diagram of an illustrative process for reconciling reference data.

### DETAILED DESCRIPTION OF THE DRAWINGS

Most business strategy and operations, especially business transaction operations, can be modeled into a unique repeatable pattern, sometimes called business-transaction pattern. Business transaction pattern can be used to solve reference data ambiguity by a combination of (i) the ability to process business transaction data as unstructured data and (ii) the ability to use business metadata modeling standards and tools to model business transactions. In accordance with the principles of the present invention, three design elements may be used to define a business transaction pattern design, and these design elements include (i) decision model, (ii) semantic model, and (iii) governance model.

Decision models may be defined for computer execution using resource description format (RDF), which is an object management group/worldwide web consortium (OMG/W3C) standard that describes each reference data possibility as an “assertion” that evaluates to a Boolean when tested against business data and/or master data. The business models may be based on decision modeling notation (DMN), which is an emerging standard. Decision models may be made up of one or many decision-tables joined by association or hierarchy using ontology modeling notation. The ontology model notation provides for the following attributes for the pattern to be complete and available for computer-execution: assertions defined in RDF triples (subject-predicate-object), operators for the predicates, and Boolean to compound the assertions. The assertions defined in RDF triples may define a decision-table.

The semantic model provides a vocabulary that describes a domain to which the policies apply, namely the business (e.g., banking business, stock trade business, shipping business, etc.). The semantic model also encodes the reference data possibilities as assertions, and describes business documents that include reference data in all forms, namely (i) unstructured (paper-based contracts, email, social media, web page, etc.), (ii) semi-structured (electronic forms), and (iii) structured (enterprise reference, position, and transaction data). Among other things, the semantic model includes very specific definitions of identity, such as fingerprinting, necessary and sufficient conditions, including completeness, and so on. In broader terms, the semantic model defines the data quality rules from a business perspective.

The semantic model may incorporate a content enrichment framework (FIG. 4) that creates tags, such as XML tags, to unstructured data by using the vocabulary of the semantic model to create the enrichment tags. These tags may be indexed by an execution engine so that the business data can be searched in an unstructured search format (e.g., keyword search tool for analysts/case workers to research transaction documents). In one embodiment, the search may incorporate a “fuzzy search” feature that uses the semantic model to render the fuzzy search when identifying “values” between the enrichment tags. As understood in the art, a fuzzy search allows for closeness of a match to be measured in terms of a number of “primitive operations” necessary to convert a search string into an exact match. The number is known as the “edit distance” between the search string and the pattern, and typically look for words that have insertions (e.g., cot->coat), deletions (e.g., coat->cot), substitutions (e.g., coat->cost), transpositions (e.g., cost->cots), and abbreviations (e.g., Ltd.->Limited). The output of these rules may be vetted against a database inclusive of people, places, and things that the content enrichment framework utilizes to create an abbreviation or other dictionary.

The semantic model may incorporate a governance model that provides core elements of governance that are defined as a part of this pattern and may include: (i) organization and roles and (ii) business-process steps. The governance model may form a matrix with business-processes along the X-axis and organizations along the Y-axis.

With regard to FIG. 1, an illustration of an illustrative business transaction environment 100 in which two parties 102a and 102b (collectively 102) are conducting a business transaction 104 is shown. The business transaction 104 may include a business transaction document 106 that provides for terms of the business transaction 104.

As further shown, the business transaction environment 100 may include a broker 108 or other third-party intermediary that operates to conduct the transaction. It should be understood that each of the parties 102 may have their own brokers, such that two or more brokers are used in conducting the transaction. In this case, a single broker 108 is being used to conduct a transaction. In that regard, party 102a and broker 108 may utilize a business transaction document 110, while party 102b and broker 108 may utilize a business transaction document 112 for conducting the business transaction. It should be understood that the business transaction documents 110 and 112 may be the same business transaction document depending on the type and nature of the business transaction.

As understood in the art, the business transaction document 106 generally includes date/time of the business transaction 104, date/time of delivery of goods/services, identities of the parties 102, identity of goods/services being transacted, and value of goods/services being transacted. Reference data in such a business transaction document may include identities of the parties 102 and identity of goods/services being transacted. As is a common occurrence, reference data in business transaction documents is deemed ambiguous or cannot be readily determined due to mismatches with other business transaction data as a result of master data used to create the business transaction data not being identical with master data used to verify or otherwise process the business transaction document (e.g., different master data used at different stages of a business, such as a sales department and an accounting department within an organization).

With regard to FIG. 2, an illustration of an illustrative corporate environment 200 in which a business transaction can be supported is shown. The corporate environment 200 may include multiple business unit operations, including a “front office” 202, “middle office” 204, and “back office” 206. Because the different offices 202, 204, and 206 operate independent of one another, each may use a different data source 208, 210, and 212, respectively, for providing master data 214, 216, and 218, respectively. As understood in the art, the master data 214, 216, and 218 may have variations, small or large, such that personnel attempting to reconcile or corroborate the business transaction based on reference data (e.g., name of stock being purchased) may have difficulty due to the variations. Such variations in the master data and/or reference data leads to inefficiencies in the middle office 204 and back office 206, as well as the front office 202 that may have to respond to inquiries from the other offices 204 and 206. And, depending on the nature of the business transactions, the closure or settlement of the business transactions may not occur due to time delay due to resolving the variations of the master data and/or transaction data.

As shown, a business transaction document 220 that may include reference data (e.g., name of stock being transacted) may enter and/or be generated by the front office 202. The front office 202 may communicate or otherwise transfer the business transaction document 220 as business transaction document 220′ to the middle office 204. The business transaction document 220′ may be indicative that the business transaction document 220′ is a modified version of the business transaction document 220 as modified by the front office 202 (e.g., timestamp or other additional data being added to the document 220 for internal processing purposes). Alternatively, the business transaction document 220′ may be identical to business transaction document 220. The middle office 204 may process the business transaction document 220″, including reconciling the reference data of the business transaction document 220′ and may communicate or otherwise transfer business transaction document 220″ to the back office 206. The back office 206 may function to perform settlements of business transactions (e.g., stock trades) using the terms of the business transaction document 220″.

To assist each of the offices 202, 204, and 206 of the company, a server 222 may be utilized to manage master data so that reference data can be unambiguously identified in a timely and efficient manner. The server 222 may include a processing unit 224 composed of one or more computer processors that execute software 226 to perform functions in accordance with the principles of the present invention. The processing unit 224 may be in communication with memory 228 and storage unit 232, which may be internal or external from the server 222. The storage unit 232 may include data repositories 234a-234n (collectively 234) that may be configured to store master data, reference data, or any other data associated with performing business transactions.

In operation, the front office 220 may communicate the business transaction document 220 to the server 222 for processing to verify the reference data. In an alternative embodiment, business transaction data, which includes the reference data, may be communicated to the server 222 as opposed to the document 220 itself. The server 222 may utilized data models to verify the reference data in the business transaction document 220, as further described herein. By way of example, the software 226 being executed by the processing unit 224 may be configured to compare the reference data to the master data being stored in the data repository 234a to confirm that the reference data matches, at least to some degree of certainty above a threshold value (e.g., 95% certainty) utilizing data and/or metadata to establish a match. In response to verifying the reference data, a verified reference data signal 236 may be communicated to the front office 202 to notify a user that the reference data has been verified. The middle office 204 and back office 206 may also communicate the business transaction document 220′ and 220″ to the server 222 for verification of the reference data in the same or similar manner. The verified reference data signal 236 may be a Boolean value and optionally include an identifier that is to be common to each of the offices 202, 204, and 206 when referring to the reference data (e.g., Goldman Sachs may use identifier “G& Co.”). The reference data stored in data repository 234n may also include an audit record of each time a reference data verification is performed, thereby allowing for auditing to be performed in a simple and traceable manner at a later date.

With regard to FIG. 3, a block diagram of a illustrative modules 300 that may be executed by a computing system for managing and processing business is shown. The modules 300 may include a policy engine 302, execution engine 304, content enrichment engine 306, and orchestration engine 308. Each of these engines 302-308 may operate in conjunction with one another. However, although each of the modules 300 are shown as a set, it should be understood that the policy engine 302 may operate separate from the other engines as once assertions are grouped into decision-tables for execution, the execution engine 304, content enrichment engine 306, and orchestration engine 308 may be operated independently. Thus, a third-party provider may generate the decision-tables for execution and a business entity may execute the decision-tables on business transaction data of business transactions, for example, as previously described.

The policy engine 302 may use ontology modeling to encode business policies as assertions in a semantic web format or web-based ontology language (OWL), such as an RDF format, where the RDF format may be an RDF triple and modeled as subject-predicate-object. The assertions may be grouped into decision-tables for execution. Each decision table is a reusable block of assertions and usage may be orchestrated by a standard business process tool. The policy model 302, thus, define data requirements and assertions for use by the execution engine 304.

The execution engine 304 may be a stateless machine that understands the assertion groups in the decision-tables. Execution is designed to enact or apply the assertions (e.g., reference data association policies, metadata association) on reference data of the business transaction data. The business transaction data may be unstructured, semi-structured, and structured such that the modules are able to identify the reference data. The business data may be “inverted indexed” to enable advanced search and query capabilities across structured, semi-structured, and unstructured data and associated dashboards, for example.

The content enrichment engine 306 may provide a framework from which a designed outcome of modeling policies as assertions for the policy engine is a domain-rich vocabulary that represents business semantics and is represented as an ontology model. The semantic ontology model enhances a natural language interpreter that allows for understanding business documentation that is in unstructured or semi-structured form, thereby allowing the reference data of the business transaction data to be processed by a computer as opposed to being manually entered.

The orchestration engine 308 is used to create a model-driven business process or pattern. The orchestration engine 308 allows the orchestration of decision-tables to enact a business process. That is, the ontology-model in the policy engine 302 determines the sequence in which the decision-tables are to be executed and represents the model that drives the business process (i.e., a model-driven business process). The orchestration engine 308 is executed as a state machine.

A reference data identification engine 310 may be configured to operate in conjunction with any of the other engines, and be configured to identify reference data. As an example, the policy engine 302 may provide industry domain terminology to identify predicates, and the reference data identification engine 310 may be used to identify reference data based on naming convention (e.g., stock symbol), metadata association (e.g., “/stk smbl/”), and/or otherwise.

In operation, business domain(s) may be modeled into the policy engine 302 as assertions using a business requirements document (BRD), and create rules for automatically “reading” documents and/or reference data in the documents. In creating the policy rules, the business domains may be broken down to terminology or nomenclature that are particular to the business entity. Three steps may be used in a decision model, including (i) create a decision table (TABLE 1) based on Decision Model Notation (DMN), (ii) perform XML encoding (TABLE 2) of a decision table as an assertion (subject-predicate-object), and (iii) convert the XML encoded decision table into XMI, whereby the XMI output (TABLE 3) may be sent to feed the assertions to the execution engine in the web-based ontology language (e.g., RDF triple).

TABLE 1
Decision Model Notation: Decision Table
Decision Table Determine LegalNameLabel

| If | | If | | Then | |
|---|---|---|---|---|---|
| $document.documentType | | $document.nounPhrase | | $document.legalNameLabel | |
| Document Type | | Noun Phrase | | Legal Name Label | |
| Is | Articles of Incorporation | Is | “Name of Company” | Is | NameOfCompany |
| Is | Articles of Organization | Is | “Name of Organization” | Is | NameOfOrganization |
| Is | Stock Transaction Form | Is | “Stock Name” | Is | businessName |

TABLE 2
Decision Model Notation: XML Encoding

<Decision name=“DetermineLegalNameLabel”>
<Decision_Rules>
<DecisionRule name=“Rule1”>
<Condition>
<Subject>
<DMN.InformationItem xmi.idref=
“DMN-InformationItem_$document.documentType”/>
</subject>
<operator>is</operator>
<operand>
<DMN.InformationItem xmi.idref = “DMN-InformationItem_Articles Of
Incorporation”/>

TABLE 3
Decision Model Notation: XMI Export (OWL)

<InformationItem xmi.id=
“DMN-InformationItem_$document.documentType”
Name=“$document.documentType”>
<Related_Element>
<OWLBase.OWLClass href=
“OWLClass-Legal Document-Document Type”/>
</Related_Element>
<Contains_Element/>
</InformationItem>

An example of a use case for verifying reference data is provided below in TABLE 4. As shown, the use case defines a portion of a requirements document that can be used for defining a model for the policy engine 302.

TABLE 4
Decision Model Notation: XMI Export (OWL)

```
 Reference Data Verification
    ∘ Reference Data: Stock Trade Data
        ▪ Equity Stock
             Stock Trade Name
                ∘ Stock Trade Master Data Lists
                    ▪ Bloomberg Master Data
                    ▪ Kingsland Master Data
                    ▪ Thompson Reuters Master Data
                    ▪ Internal Master Data
```

A reference data search engine 312 may be configured to enable a user to perform a search of business transaction data using an unstructured data search tool. The reason for being able to perform such a search on the actual business transaction data, including reference data or any other relevant data related to the industry domain in which the business transactions are occurring, is that the business data being processed in the business transaction documents is being modeled using the RDF triple data format such that the collected data can be stored in an unstructured or NoSQL database.

A master data management engine 314 may be configured to manage master data that may be a combination of master data from third-party sources and/or master data collected and managed by a company (e.g., bank). The master data may be any reference data that may be used to identify reference data (e.g., company name associated with stock trading). In one embodiment, the master data management engine 314 may be configured to allow the master data stored in a data repository to be dynamic as the engine 314 “learns” of new and different terms that refer to reference data. For example, as new reference data is collected that refers to other reference data (or master data) that was previously not stored relative to the reference data as being stored in the master data, that new reference data may be added. In addition, other data, such as metadata associated with the reference data in a business transaction may be collected and stored with the master data or in another data repository that may or may not be associated to the master data.

With regard to FIG. 4, a block diagram of an illustrative content enrichment framework 400 is shown. The content enrichment framework 400 is shown to include a content enrichment engine 402 and policy engine 404 from which metadata 406 may be communicated into the content enrichment engine 402. The content enrichment engine 402 may use regulatory vocabulary 408, public entity data 410, and algorithms 412 to perform natural language processing by a document enrichment engine 414 that performs XML tagging. The content enrichment engine 402 may enrich business data that is derived from business transaction documents 406 that may be scanned via an OCR system 418 (or electronic, PDF, or eForm documents) that creates computer readable documents 420. Output from the document enrichment engine 414 may be XML tagged business data (not shown) that is indexed, optionally inverted indexed, by an indexing engine 422. Once indexed, the business data, which is now content searchable in an unstructured format, may be stored in an XML repository 424 for further processing by an execution engine (not shown). As understood in the art, the unstructured format, which may be considered a non-structured or NoSQL database format that may provide for significantly more flexibility (e.g., provides for freeform searches) than conventional structured or SQL database configurations that currently exist. The NoSQL database may store the business data in a native unstructured format.

With regard to FIG. 5, an illustration of an illustrative execution engine environment 500 is shown. The execution engine environment 500 may include an execution engine 502 that includes a parser 504 configured to parse assertions 506 received from a policy engine 508. The assertions 506 may define models for identifying master data related to reference data in business transaction documents. A business process manager (BPM) or orchestration engine 510 may communicate a process name and user provided data 512 to be executed. A content enrichment framework 514 may send business transaction data in the form of XML documents 516 to the execution engine 502 for processing as orchestrated by the BPM 510. That is, the execution engine 502 executes each related policy assertion against all of the business transaction data, including XML document(s) 516, user provided data 512, and data 518 from external source(s) 520 and/or internal source(s) 522 to evaluate success, partial success, or failure of identifying reference data in master data available to support a reference data reconciliation process.

With regard to FIG. 6 is a screenshot of an illustrative user interface 600 that enables a user to select master data of which reference data derived from a business transaction document is to be identified is shown. The user interface 600 may be caused to be automatically prompted for a user in response to a determination that reference data of a business transaction has ambiguity. Ambiguity of reference data may be determined after the system attempts to resolve the reference data by attempting to resolve or reconcile the reference data against one or more master datasets, as previously described herein. In an alternative embodiment, the user may review a list of business transactions that are flagged with ambiguous reference data and select a transaction with an ambiguity to resolve the ambiguity via the user interface 600. It should be understood that the user interface 600 is illustrative and that any additional and/or alternative information may be presented to the user to further assist the user in resolving the ambiguity of the reference data. Such additional information may include a lookup feature that allows the user to perform searching or otherwise review master data that could potentially identify the reference data with the ambiguity.

The user interface 600 may include a business transaction section 602, business transaction reference data section 604, and business transaction document section 606. The business transaction section 602 may include a business transaction identifier data field 608, transaction date data field 610, transaction type data field 612, and so forth. Other business transaction data may include price of the transaction, option period of the transaction, or any other business transaction variables, as understood the art.

The business transaction reference data section 604 may include a buyer identifier data field 614, seller identifier data field 616, stock name 618 (assuming the business domain is associated with buying and selling stocks), alert indicator 620, and possible identity table 622. The table 622 may include a list 624a-624n (collectively 624) that lists all possible identities of a reference data element, in this case a stock name, which is established by the alert indicator 620. If, for example, an alert indicator (not shown) were associated with the buyer name data field 614, then the table 622 may display possible identities of the buyer from which a user could select. Also shown in association with the list 624 of possible identity identities of the reference data may be percentages 626a-626n (collectively 626) that each entry is a correct reference identifier based on comparing the reference data as well as other context metadata or other metadata associated with the reference data and/or business transaction document. In other words, the system may use any data available from the business document to ascertain and rank possible identities of reference data from a master dataset.

The business transaction document section 606 may include selectable user elements 626, such as source or reference data selectable elements. If the user selects the source user element, then an image 628 inclusive of a source document from which business transaction data and reference data was derived may be displayed. In the event that the user selects the reference data element, additional information, such as RDF triple data inclusive of industry domain predicates along with their respect subjects and objects, may be displayed. Once the user determines and selects an identity (or inputs an identify if a possible identity of the reference data is not determined from the master data list presented) via the list 622, such as shown with the selected list element 624a, the user may select the “submit” soft-button to submit the selected possible identify of the reference data.

With regard to FIG. 7 is a screenshot of an illustrative user interface 700 that enables a user to search for business transaction data of a business transaction document is shown. The user interface 700 may include transaction date(s) entry fields 702 that may enable a user to enter one or two dates during which a transaction may have been performed. A party name or other identifier text input field 704 may enable the user to enter a name or identifier of a party that was part of the transaction. A freeform search string field 706 that enables a user to enter a freeform search string to perform research in a NoSQL database may also be provided in the user interface 700. As previously described, the reason that they freeform search string may be utilized is as a result of data modeling of content within business transaction documents being established in a RDF triple or other natural language format that may be defined by standard or proprietary data models.

With regard to FIG. 8, a flow diagram of an illustrative process 800 for reconciling reference data is shown. The process 800 may start a step 802, where a business transaction document may be parsed. In parsing the business transaction document, RDF triple data (i.e., subject-predicate-object) may be identified and collected. In accordance with the principles of the present invention, the RDF triple data may be subject matter or relevancy limited by an industry domain as defined by a policy engine (e.g., policy engine 402). The use of a policy engine along with vocabulary, algorithms, and any other data that limits RDF triple data to be that of a particular industry domain may reduce extraneous business transaction data that is collected from business transaction documents. As an example, if business transaction documents are inclusive of emails or other business documents, then the business transaction data that is collected will be limited to relevant terms that a user may wish to search for that may be helpful in identifying reference data for resolution during a reconciliation or other business process in performing the transaction.

At step 804, at least one predicate of interest in the transaction document may be determined. As previously described, a predicate of interest is one that is related to an industry domain, such as stock transactions, transportation transactions, shipping transactions, medical care transactions, or any other business transaction, as understood in the art. The predicates of interest may be diverse as defined by the vocabulary of the policy engine.

At step 806, a transaction dataset may be generated. The transaction dataset may be inclusive of transaction data in an RDF triple data format that includes at least one predicate of interest. At step 808, reference data of the transaction dataset may be determined. The reference data may be determined based on a predicate of an RDF triple, metadata associated with the transaction business data, combination thereof, or any other technique for determining reference data of a business transaction.

At step 810, reference data may be compared with master data representative of potential identities to which the reference data of the business transaction refers. The comparison may utilize both reference data values as well as metadata associated with the reference data values. Moreover, context metadata that may be added by the system may be utilized in helping to identify reference data with respect to master data that is managed by a corporation or third-party.

At step 812, a determination of correct identity of the reference data may be determined. The determination may be performed automatically in response to identifying reference data having a percent of correctness above a threshold value (e.g., threshold value 95%). Additionally and/or alternatively, the identity of the reference data may be determined in response to a user being prompted or otherwise notified that some level of ambiguity of reference data has been determined in that a user is to assist in resolving the ambiguity by being presented master data or otherwise allowing the user to resolve the ambiguity in any other manner.

The previous description is of a preferred embodiment for implementing the invention, and the scope of the invention should not necessarily be limited by this description. The scope of the present invention is instead defined by the following claims.

What is claimed:

1. A method of reconciling reference data of a business transaction, said method comprising:
in response to receiving a document associated with a business transaction, parsing, by a processing unit, the document to identify at least one set of a subject, predicate, and object data contained within the document;
determining, by the processing unit, at least one predicate of interest from the at least one set of a subject, predicate, and object data;
generating, by the processing unit, a transaction data set in an RDF triple data format for each set of subject, predicate, and object data inclusive of the at least one predicate of interest;
determining, by the processing unit, reference data of a transaction data set;
comparing, by the processing unit, the reference data with master data representative of potential identities to which the reference data of the business transaction refers; and
determining, by the processing unit, a correct identity of the reference data.

2. The method according to claim 1, further comprising:
storing the at least one transaction data set in a NoSQL database;
generating, by the processing unit, context metadata associated with the business transaction; and
storing, by the processing unit, the context metadata in association with the transaction data stored in the RDF triple data format in the NoSQL database.

3. The method according to claim 2, further comprising:
comparing, by the processing unit, the context metadata and reference data with master data; and
determining, by the processing unit, actual reference data based on comparing the context metadata and reference data with the master data.

4. The method according to claim 3, further comprising storing the actual reference data in association with the transaction data being stored in the RDF triple format.

5. The method according to claim 4, further comprising:
determining, by the processing unit, that the actual reference data cannot be identified; and
causing, by the processing unit, a prompt to be displayed to a user to request that the user identify the actual reference data.

6. The method according to claim 5, further comprising:
determining a set of most likely reference data from the master data based on transaction data sets and context metadata,
wherein causing the prompt includes causing a message including a selectable list of the set of most likely master data elements to which the reference data refers to be presented to the user; and
responsive to a user selection of a most likely master data element, associating the reference data to that master data element for further processing of the business transaction.

7. The method according to claim 2, further comprising:
receiving, by the processing unit, a keyword search request in a freeform search string for transaction data being stored in the RDF triple data format in the NoSQL database;
searching, by the processing unit, for transaction data that is determined to match the keyword search request; and
returning, by the processing unit, the matching transaction data.

8. The method according to claim 7, wherein searching for transaction data that is determined to match includes searching for transaction data that is determined to match above a match percentage value.

9. The method according to claim 2, wherein generating the metadata context includes generating a transaction type of the business transaction being conducted.

10. The method according to claim 1, further comprising:
identifying a buyer of the business transaction;
in response to confirming the buyer of the business transaction using the master data, storing an identifier indicative of the identify of the buyer; and
identifying a seller of the business transaction; and
in response to identifying the seller of the business transaction using the master data, storing an identifier indicative of the identity of the seller in association with the at least one transaction data set.

11. The method according to claim 1, further comprising:
storing the master data, wherein at least one set of master data includes a plurality of identifiers indicative of a single reference data value; and
in response to the user selecting a master data element, updating the master data with the reference data associated with the corresponding master data element.

12. The method according to claim 1, wherein parsing the data includes:
identifying reference data of the data of the business transaction;
determining whether the reference data can be unambiguously identified; and
if the reference data can be unambiguously identified, enabling the reference data to be stored,
otherwise causing a user to be prompted to assist in identifying the reference data.

13. A system of reconciling reference data of a business transaction, said system comprising:
a storage unit;
a processing unit in communication with said storage unit and configured to:
in response to receiving a document associated with a business transaction, parse the document to identify at least one set of a subject, predicate, and object data contained within the document;
determine at least one predicate of interest from the at least one set of a subject, predicate, and object data;
generate a transaction data set in an RDF triple data format for each set of subject, predicate, and object data inclusive of the at least one predicate of interest;
determine reference data of a transaction data set;
compare the reference data with master data representative of potential identities to which the reference data of the business transaction refers; and
determine a correct identity of the reference data.

14. The system according to claim 13, wherein said processing unit is further configured to:
store, in said storage unit, the at least one transaction data set in a NoSQL database;
generate context metadata associated with the business transaction; and
store, in said storage unit, the context metadata in association with the transaction data stored in the RDF triple data format in the NoSQL database.

15. The system according to claim 14, wherein said processing unit is further configured to:
compare the context metadata and reference data with master data; and
determine actual reference data based on comparing the context metadata and reference data with the master data.

16. The system according to claim 15, wherein said processing unit is further configured to store the actual reference data in association with the transaction data being stored in the RDF triple format.

17. The system according to claim 16, wherein said processing unit is further configured to:
determine that the actual reference data cannot be identified; and
cause a prompt to be displayed to a user to request that the user identify the actual reference data.

18. The system according to claim 17, wherein said processing unit is further configured to:
determine a set of most likely reference data from the master data based on transaction data sets and context metadata,
wherein said processing unit, in causing the prompt, further causes a message including a selectable list of the set of most likely master data elements to which the reference data refers to be presented to the user; and
responsive to a user selection of a most likely master data element, associate the reference data to that master data element for further processing of the business transaction.

19. The system according to claim 14, wherein said processing unit is further configured to:
receive a keyword search request in a freeform search string for transaction data being stored in the RDF triple data format in the NoSQL database;
search for transaction data that is determined to match the keyword search request; and
return the matching transaction data.

20. The system according to claim 19, wherein said processing unit is further configured to search for transaction data that is determined to match above a match percentage value.

21. The system according to claim 14, wherein said processing unit is further configured to generate a transaction type of the business transaction being conducted.

22. The system according to claim 13, wherein said processing unit is further configured to:
identify a buyer of the business transaction;
in response to confirming the buyer of the business transaction using the master data, store an identifier indicative of the identify of the buyer; and
identify a seller of the business transaction; and
in response to identifying the seller of the business transaction using the master data, store an identifier indicative of the identity of the seller in association with the at least one transaction data set.

23. The system according to claim 13, wherein said processing unit is further configured to:
store the master data, wherein at least one set of master data includes a plurality of identifiers indicative of a single reference data value; and
in response to the user selecting a master data element, update the master data with the reference data associated with the corresponding master data element.

24. The system according to claim 1, wherein said processing unit, in parsing the data, is further configured to:
identify reference data of the data of the business transaction;
determine whether the reference data can be unambiguously identified; and
if the reference data can be unambiguously identified, enable the reference data to be stored,
otherwise cause a user to be prompted to assist in identifying the reference data.
